(19) United States
(12) Patent Application Publication
(10) Pub. No.: US 2006/0064882 A1
(43) Pub. Date: Mar. 30, 2006

(54) Reciprocationg saw and guard rail assembly therefor

(76) Inventors: Mike Wilson, Crook (GB); Neil Walmsley, Ferryhill (GB)

Correspondence Address: Michael P. Leary;Black & Decker Corporation, Mail Stop TW199, 701 E. Joppa Road, Towson, MD, 21286, US

(21) Appl. No.: 10/952,263

(22) Filed: Sep. 28, 2004

(51) Int. Cl. B23D 49/16

(52) U.S. Cl. 30/392; 30/374

(57) ABSTRACT

A jigsaw comprises a body housing a motor and a drive mechanism to convert the rotary output of the motor into reciprocal motion of the drive the blade. The body 1 is mounted on a shoe which has two forward projecting arms. A guard rail is mounted on the shoe at the front end of the arms and comprises a horizontal bar supported by upright portions which respectively engage the arms. The guard rail is formed from a single metal bar.

### FIELD OF THE INVENTION

The present invention relates to a guard rail assembly for a working member of a reciprocating tool and relates particularly, but not exclusively, to a guard rail assembly for the blade of a reciprocating jig saw.

### BACKGROUND OF THE INVENTION

Jigsaws are power tools which comprise a reciprocating saw blade for cutting a workpiece of wood or other material. Jigsaws generally comprise a body housing an electric motor and a drive mechanism to convert the rotary motion of an output shaft of the motor into reciprocal motion of the blade. Jigsaws are also provided with a supporting shoe in the form of a flat surface which rests on the workpiece and provides a reaction surface for cutting. The jigsaw body may also be able to pivot laterally about the longitudinal axis of the jigsaw to enable bevel cutting of the workpiece.

A further feature of many jigsaws is a guard rail mounted on the underside of the body of the jigsaw which extends forwardly of the saw blade to prevent objects from coming into contact with the saw blade above the shoe, so that only the workpiece below the shoe comes into contact with the blade. A problem arises with guard rails of this type when the jigsaw is being used for bevel cutting. The guard rail on the jigsaw body may come into contact with the upper surface of the shoe when the body of the jigsaw is tilted. This effectively limits the angular range of bevel cuts that can be achieved. The problem also arises that the user's line of sight to the blade may be obstructed by the guard rail.

Preferred embodiments of the present invention seek to overcome the above disadvantages of the prior art.

### BRIEF SUMMARY OF THE INVENTION

According to an aspect of the present invention, there is provided a shoe assembly for a reciprocating tool having a body, a rotary output shaft and a working member adapted to execute reciprocating movement in response to rotation of said rotary output shaft, the assembly comprising:—
a base plate adapted to be mounted to said body of said tool and to engage a workpiece, wherein the base plate includes an aperture to allow the working member to pass therethrough during reciprocating movement thereof; and
guard means adapted to be mounted to the base plate for restricting access to said output member between the base plate and the body.

By providing a guard means mounted on the base plate of the tool, this provides the advantage that when the tool is tilted for bevel cutting, the body of the tool is prevented from coming into contact with the guard means, thereby providing an increased range of bevel cutting angles. A further advantage is provided in that a flush cut blade can extend forwardly almost to the front of the base plate, but behind the guard means. This allows the tool to cut a portion of a workpiece even when the body of the tool is prevented from passing over that portion of the workpiece. Moreover, the advantage is provided that the guard means prevents objects other than the workpiece from coming into contact with the working member of the tool.

In a preferred embodiment, the guard means is adapted to be mounted to at least one groove formed in said base plate. This provides the advantage that the guard means reinforces the shoe of the jigsaw. In a preferred embodiment, at least one said groove is formed in the underside of said base plate. At least one said groove may extend from the underside of said base plate along a forward edge of the base plate. This provides the advantage that the forward edge of the guard rail protects the front of the shoe. The assembly may comprise first and second grooves formed respectively on either side of said aperture. At least one groove may comprise a slot for resiliently receiving a portion of said guard means.

In a preferred embodiment, said guard means comprises at least one guard rail. At least one said guard rail may be supported by two respective substantially upright portions mounted in use to said first and second respective grooves formed in said base plate.

The assembly may further comprise a dust guard adapted to engage said guard means. This provides the advantage that dust is prevented from projecting in front of the tool and obscuring the view of the operator.

The guard means may be removable from said base plate. This provides the advantage that flush cut blades of even greater forward projection can be fitted to the tool.

Said guard means may be formed from a single piece of steel.

According to another aspect of the present invention, there is provided a reciprocating tool comprising:—
a body;
motor means having a rotary output shaft;
drive means for converting rotary movement of said output shaft to reciprocating movement of a working member; and
a shoe assembly as defined above.

In a preferred embodiment, said reciprocating tool comprises a jigsaw.

Said motor means may be an electric motor.

### BRIEF DESCRIPTION OF THE DRAWINGS

Preferred embodiments of the present invention will now be described, by way of example only and not in any limiting sense, with reference to the accompanying drawings in which:—

FIG. 1 is a front perspective view of a jigsaw embodying the present invention and fitted with a standard blade;

FIG. 2 is a front perspective view of the jigsaw of FIG. 1 fitted with a flush cut blade;

FIG. 3 is a close up front perspective view of the flush cut blade of FIG. 2;

FIG. 4 is a perspective view of the jigsaw shoe showing the guard rail assembly and ball indent;

FIG. 5 is a perspective view of a jigsaw body engaging the shoe of FIG. 4; and

FIG. 6 is a perspective view of the underside of a base plate of a second embodiment of the invention.

### DETAILED DESCRIPTION OF THE INVENTION

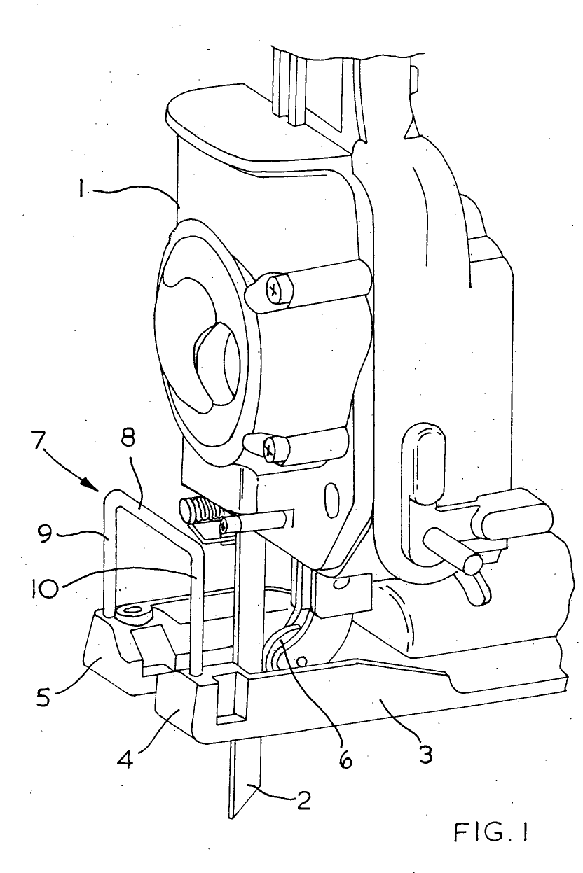

Referring to FIG. 1, a jigsaw comprises a body 1 (only the front of which is shown in FIG. 1) housing a motor (not shown) and a drive mechanism (not shown) to convert the rotary output of the motor into reciprocal motion to drive a blade 2. The body 1 is mounted on a shoe 3 which is formed from a metal cast and has two forwardly projecting arms 4, 5. The blade 2 is supported by a blade support roller 6 which provides a reaction force for the blade along the longitudinal axis of the jigsaw during cutting. A guard rail, shown generally by 7, comprises a horizontal bar 8 supported by upright portions 9, 10 which respectively engage arms 4, 5. The guard rail 7 is formed from a single metal bar bent into shape.

During operation of the jigsaw, the underside of the shoe 3 is placed on the workpiece to be cut. The teeth (not shown) of the blade 2 are angled such that on the upstroke of the blade the workpiece is cut, and on the downstroke of the blade any swarf that is produced is cleared away. The shoe therefore provides a reaction force for the cutting on the upstroke of blade 2.

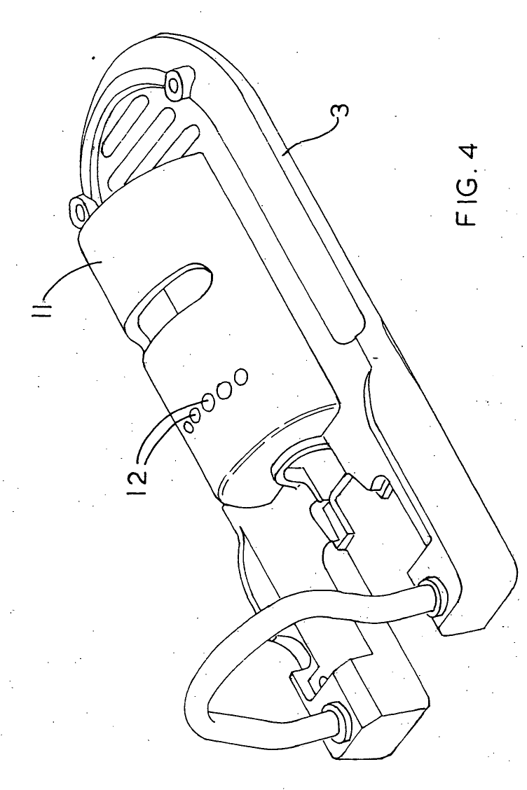

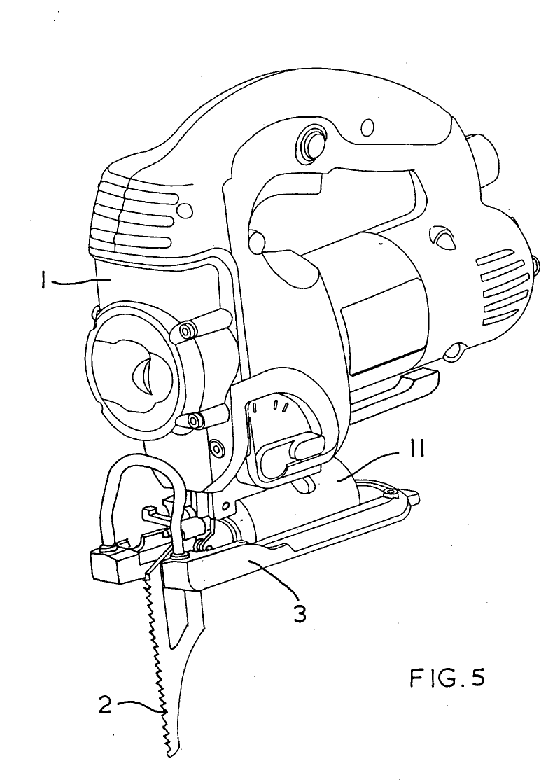

A further feature of the jigsaw is the ability of the body 1 to pivot about the longitudinal axis of the shoe 3 in order to produce bevelled cutting. Referring to FIGS. 4 and 5, the shoe 3 comprises a raised portion 11 adapted to receive the body 1. As can be seen more clearly in FIG. 4, a series of indentations 12 are formed on the raised portion 11, extending in a line across the raised portion 11 transverse to the longitudinal axis of the shoe 3.

A deflectable ball bearing (not shown) mounted on the underside of the body 3 is adapted to be resiliently received in one of the indentations 12 in order to secure the body 1 at a specific angle relative to the shoe 3. By pivoting the body 1 about a longitudinal axis relative to the shoe 3, the user can select the angle at which the body 1 is held by the deflectable bearing (not shown), and therefore select the angle of the bevel cut produced by the blade 2. In FIG. 5, the body is shown in the upright position such that the blade 2 is generally perpendicular to the base of the shoe 3.

The present invention overcomes the problem associated with prior art jigsaws of the range of angles available for bevel cutting being restricted by a body mounted guard rail. When a guard rail is mounted on the underside of the body projecting forwardly around the saw blade of the present invention, the side arms of the guard rail will eventually come into contact with the shoe as the body 1 is tilted about the shoe. Consequently, a guard rail 7 mounted on the forward part of the shoe 3 overcomes this problem, because the guard rail and body are remote from one another at all angles of inclination. The guard rail of the present invention also obscures the line of sight of a user of the jigsaw to a lesser extent than a prior art guard rail mounted to the body of the jigsaw.

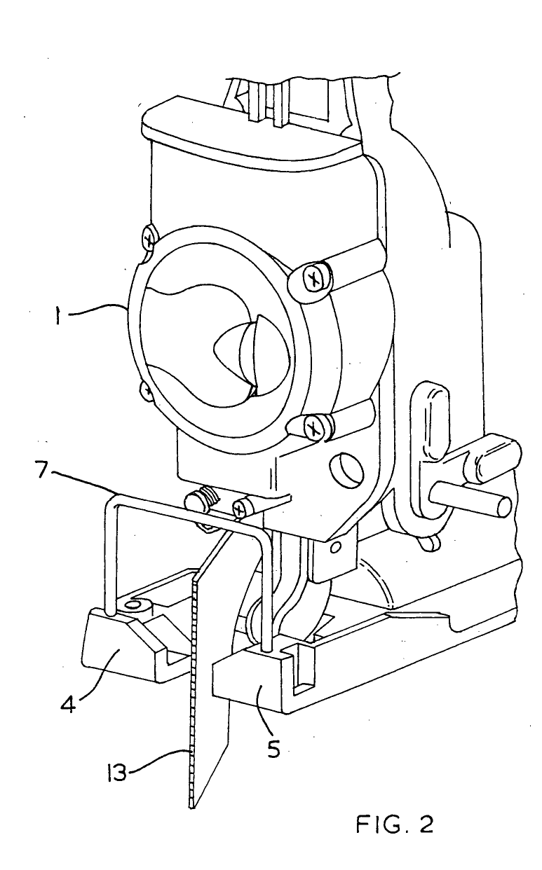

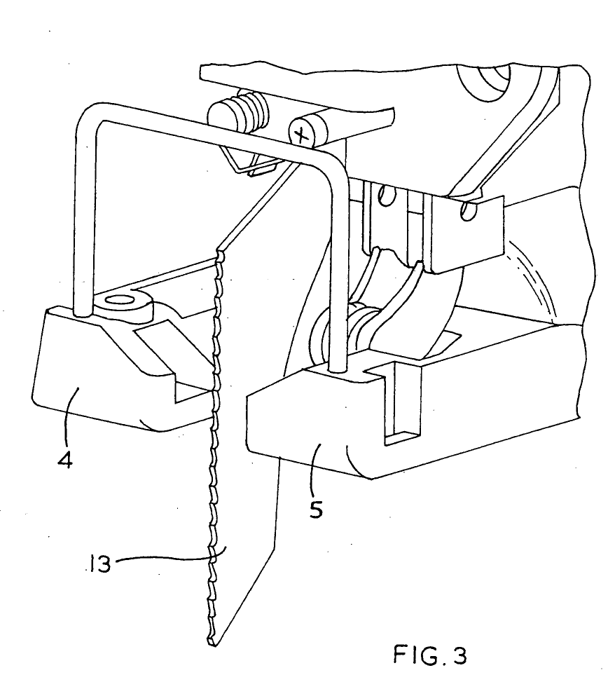

Referring now to FIGS. 2 and 3, a jigsaw is shown fitted with a flush cut blade 13. A flush cut blade 13 is useful for cutting a workpiece in restricted spaces. In FIG. 1, the forward arms 4, 5 of the shoe 3 project forwardly from the edge of the standard blade 2. If the front edges of arms 4, 5 come into contact with an obstruction such as a wall, the cut will fall short of the wall by a distance of the front edge of the blade 2 to the front edges of the arms 4, 5.

A flush cut blade overcomes this problem. As shown in FIGS. 4 and 5, the front edge of the blade 13 extends to a point that is nearly level with the edges of arms 4, 5. A further advantage of the shoe mounted guard rail 7 is that the guard rail 7 does not restrict the forward extent of the flush cut blade. A shoe mounted guard rail also permits the fitting of a dust shield (not shown).

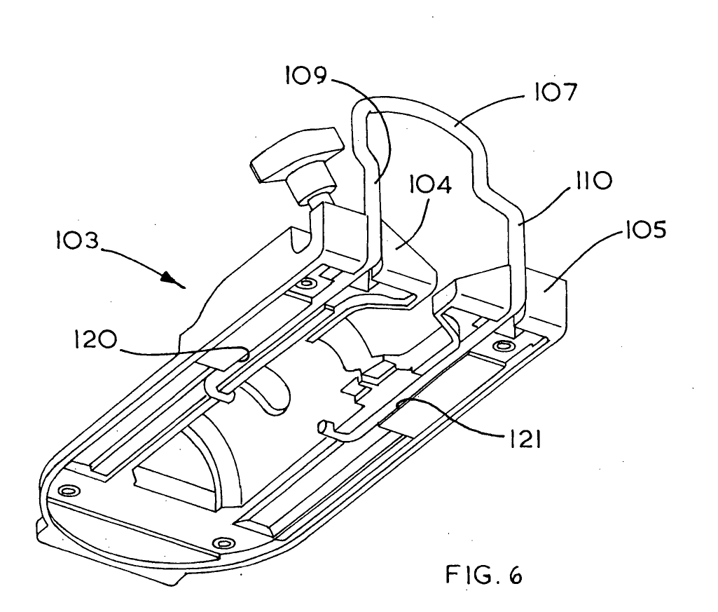

Referring now to FIG. 6, a second embodiment of the present invention is shown with parts common to the embodiment of FIGS. 1 to 5 denoted by like reference numerals but increased by 100. A jigsaw shoe 103 comprises two forwardly projecting arms 104, 105. In the front of the two forwardly projecting arms 104, 105 and in the underside of arms 104, 105, two slots 120, 121 are formed, the slots 120, 121 adapted to receive the guard rail 107. The upright portions 109, 110 of the guard rail 107 are bent, such that they can be resiliently received in slots 120, 121. By extending the upright portions 109, 110 into slots 120, 121 formed in the underside of the shoe, the rigidity of the shoe is reinforced.

By locating the upright portions 109, 110 in the slots formed in the front of the two forwardly projecting arms 104, 105 the guard rail 107 is located at the most forward point of the jigsaw shoe 103.

It will be appreciated by persons skilled in the art that the above embodiments have been described by way of example only and not in any limitative sense, and that various alterations and modifications are possible without departure from the scope of the invention as defined by the appended claims.

1. A shoe assembly for a reciprocating tool having a working member adapted to execute reciprocating movement, the assembly comprising:—
a body;
a base plate adapted to be mounted to said body of said tool and to engage a workpiece, wherein the base plate includes an aperture to allow the working member to pass therethrough during reciprocating movement thereof; and
guard means adapted to be mounted to the base plate for restricting access to said working member between the base plate and the body.

2. An assembly according to claim 1, wherein the guard means is adapted to be mounted to a groove formed in said base plate.

3. An assembly according to claim 2, wherein the groove is formed in the underside of said base plate.

4. An assembly according to claim 3, wherein the groove extends from the underside of said base plate along a forward edge of the base plate.

5. An assembly according to claim 2, wherein the groove constitutes a first groove and the assembly further comprises a second groove, and the first groove and the second groove are formed respectively on either side of said aperture.

6. An assembly according to claim 2, wherein the groove comprises a slot for resiliently receiving a portion of said guard means.

7. An assembly according to claim 2, wherein said guard means comprises a guard rail.

8. An assembly according to claim 7, wherein the guard rail is supported by a substantially upright portion mounted in use to the groove.

9. An assembly according to claim 8 wherein the guard rail is located at the front of the base plate.

10. An assembly according to claim 1 and further comprising a dust guard adapted to engage said guard means.

11. An assembly according to claim 1, wherein said guard means is removable from said base plate.

12. An assembly according to claim 1, wherein said guard means is formed from a single piece of steel.

13. A reciprocating tool comprising:—
a body;
a working member; and
a shoe assembly including:
a base plate adapted to be mounted to said body of said tool and to engage a workpiece, wherein the base plate includes an aperture to allow the working member to pass therethrough during reciprocating movement thereof; and
guard means adapted to be mounted to the base plate for restricting access to said working member between the base plate and the body.

14. A reciprocating tool according to claim 13, wherein said reciprocating tool comprises a jigsaw.

15. A jig saw for reciprocating a blade through a workpiece, the jig saw comprising:
a saw body, the blade operatively connectable to the saw body;
a saw shoe for supporting the jig saw against the work piece, the saw body adjustably connected to the saw shoe for pivotable positioning relative to the saw shoe, the saw shoe defining an opening through the saw shoe;
a space defined between the saw body and the saw shoe, and the blade extending from the saw body through the space between the saw body and the saw shoe and through the opening in the saw shoe; and
a blade guard connectable to the saw shoe and positioned to at least partially obstruct access to the space defined between the saw body and the saw shoe.

16. A jig saw according to claim 15, wherein the saw shoe includes a first forward projecting arm and a second forward projecting arm, and the blade guard includes a first upright portion and a second upright portion, and wherein the first upright portion of the blade guard is connectable to the first forward projecting arm of the saw shoe and the second upright portion of the blade guard is connectable to the second forward projecting arm of the saw shoe.

17. A jig saw according to claim 15, wherein the saw shoe includes a forward projecting arm and the blade guard includes an upright portion, and the upright portion of the blade guard is connectable to the forward projecting arm of the saw shoe.

18. A jig saw according to claim 15, wherein the saw body includes a forward-most portion and the saw shoe includes a forward edge that extends further forward than the forward-most portion of the saw body, and the blade guard is connectable to the saw shoe adjacent to the forward edge and the blade guard projects upward substantially in a plane, which plane of the blade guard is forward of the forward-most portion of the of the saw body.
